(19) United States
(12) Patent Application Publication
(10) Pub. No.: US 2024/0308572 A1
(43) Pub. Date: Sep. 19, 2024

(54) STEERING SYSTEM

(71) Applicant: ZF Automotive Germany GmbH, Alfdorf (DE)

(72) Inventor: Ian Bläser, Bochum (DE)

(21) Appl. No.: 18/602,331

(22) Filed: Mar. 12, 2024

(30) Foreign Application Priority Data
Mar. 13, 2023 (DE) 102023202250.8

(51) Int. Cl. B62D 5/04

(52) U.S. Cl. CPC B62D 5/0424

(57) ABSTRACT

A steering system for a vehicle is disclosed, for example a steer-by-wire steering system or an electric power steering system. The steering system includes a linearly displaceable steering rod, a spindle nut which is coupled to the steering rod and which is rotatable to displace the steering rod, and a detection device for detecting a rotational position of the spindle nut. The detection device comprises a magnetic target object, which is directly or indirectly rotationally coupled to the spindle nut, a magnetic sensor for detecting the rotational position of the magnetic target object, and a revolution counter for detecting a number of revolutions of the magnetic target object. The magnetic sensor and the revolution counter are present in a common integrated circuit.

### CROSS-REFERENCE TO RELATED APPLICATION

This application claims priority to German Priority application Ser. No. 102023202250.8, filed Mar. 13, 2023, the disclosure of which is incorporated herein by reference in its entirety.

### TECHNICAL FIELD

The disclosure relates to a steering system for a motor vehicle, for example, a steer-by-wire system or an electric power steering system.

### BACKGROUND

In steer-by-wire and/or electric power steering systems, a drive motor which displaces a steering rod is provided to set a steering angle at the wheels of the vehicle.

In steer-by-wire steering systems, there is no mechanical connection between the steering wheel and the steering rod. The position of the steering wheel is detected electronically and a corresponding displacement of the steering rod is achieved by a drive motor.

In electric power steering systems, although there is a mechanical connection between the steering wheel and the steering rod, the displacement of the steering rod is likewise assisted by a drive motor.

To ascertain the steering angle, there are sensors for the indirect detection of the steering angle by using a steering rod position or by using a rotational position of a drive pinion interlocked with the steering rod. In current systems, these sensors are generally integrated in a so-called “pinion tower”, in which the drive pinion is accommodated.

According to a known variant, to ascertain the steering angle there are two rotational angle sensors which, for example, are based on a magnetic, inductive, resistive, or optical active principle. The rotational angle sensors have a different transmission ratio relative to the drive pillion, so that a phase difference is produced between the sensor signals, by using which an absolute position of the drive pinion, i.e., a rotational position and a number of revolutions, can be ascertained.

The disadvantage with such systems is that two sensor circuits are required, since the rotational angle of two gear wheels must be detected in order to be able to determine the steering angle unambiguously. As a result, this solution is associated with high costs. Furthermore, in such systems, the production tolerances have a direct influence on the sensor signals and therefore on the ascertained steering angle, so that the system must be produced with high accuracy.

In a further known variant, a rotational angle sensor is provided in combination with an index sensor, which is able to detect a number of revolutions of a drive pinion. In operation, a rotational angle signal over 360° and an index signal are output, a control unit counting the complete revolutions of the drive pinion by using the signal from the index sensor. The disadvantage with rotational angle sensors with index sensors is that no absolute position can be delivered independently thereby when starting the vehicle. Instead, that access must be made to a memory in the control unit. When the vehicle is switched off, the control device must store the index value in order to be able to determine the correct steering angle at the next start. However, this entails the risk that the control unit will lose the value or change the latter, which would lead to a false absolute position in the steering, Thus, such sensors cannot provide a guaranteed true power-on-function. A true power-on-function means that when the vehicle is restarted, an absolute steering angle can be determined unambiguously solely on the basis of the sensor signals.

### SUMMARY

What is needed is a steering system which is designed compactly and cost-effectively and can implement a true power-on-function.

According to the disclosure, a steering system for a vehicle is disclosed, for example, a steer-by-wire steering system or an electric power steering system, having a linearly displaceable steering rod, a spindle nut which is coupled to the steering rod and which is rotatable to displace the steering rod, and having a detection device for detecting a rotational position of the spindle nut. The detection device comprises a magnetic target object, which is directly or indirectly rotationally coupled to the spindle nut, a magnetic sensor for detecting the rotational position of the magnetic target object, and a revolution counter for detecting a number of revolutions of the magnetic target object. The magnetic sensor and the revolution counter are present in a common integrated circuit. For example, this does not involve two sensor circuits which are present in a common circuit system but a single sensor circuit, in which the magnetic sensor and the revolution counter are integrated.

Since the magnetic sensor and the revolution counter are integrated in a common circuit, a compact design is achieved on account of a number of electronic and magnetic components that is reduced as compared with known solutions. As a result, the steering system is also cost-effective.

According to the disclosure, the signal from a single target object is used by two different sensors, i.e. by the magnetic sensor and the revolution counter, whereby the compact design can be implemented,

Due to the magnetic sensor and the revolution counter, an absolute position of the steering rod can be ascertained unambiguously and thus a steering angle can be determined unambiguously. Since both a rotational position of the spindle nut, based on 360°, can be ascertained by the magnetic sensor and also a number of revolutions of the spindle nut can be ascertained by the revolution counter, a true power-on-function is ensured.

A further advantage of the steering system according to the disclosure is that production tolerances have only a slight influence on the detected sensor signals, so that an absolute position of the steering rod can be determined with high accuracy.

The revolution counter is based on the operating principle of magnetic resistance. In practical terms, the revolution counter comprises an electrically and magnetically conductive structure which changes its resistance value on the basis of the influence from an external rotating magnetic field. The resistance values can be used as a code for a current number of revolutions. More precisely, it is possible to infer the number of revolutions by using a resistance value from the revolution counter.

In one exemplary arrangement, the revolution counter is based on the use of so-called domain walls which are displaced under the influence of the rotating magnetic field. A domain wall is an interface which divides magnetic domains. In other words, a domain wall is a transition between different magnetic moments.

The electrically and magnetically conductive structure is spiral in shape, wherein a detectable number of revolutions is ascertained by using the number of the winding. The more windings there are, the more revolutions can be counted.

Revolution counters of this type are disclosed, for example, in DE 1 2019 113 908 A1 and in DE 10 2018 222 879 A1.

The number of revolutions is counted on the basis of an initial position. This means that with increasing deflection of the steering rod, the number of counted revolutions increases. if the steering rod is moved back into a neutral position, the number of counted revolutions decreases again. This principle is equally true of a deflection in both directions.

The system can be designed redundantly, which means that the magnetic sensor and the rotational angle sensor can be present twice.

The steering system comprises, for example, a drive motor for rotating the spindle nut, wherein the drive motor is connected to the spindle nut via a toothed belt, which is in engagement with a motor shaft of the drive motor and the spindle nut. The drive motor can consequently be arranged parallel to the steering rod, which likewise contributes to a compact design of the steering system.

According to one exemplary arrangement, the magnetic target object is co-rotationally coupled to the motor shaft. The steering angle is thus determined indirectly by the motor position. By using the motor position, the steering angle can be determined with high accuracy.

In an alternative arrangement, the magnetic target object is coupled mechanically to the toothed belt, The advantage with this arrangement is that the magnetic target object and in also the magnetic sensor and the revolution counter can be arranged in a dead space between the drive motor and the threaded nut, which contributes to a compact design.

The magnetic target object comprises a gear wheel and a permanent magnet fixed to the gear wheel. Thus, the permanent magnet can be reliably coupled via the gear wheel to a further element, which contributes to a high measurement accuracy.

For example, the gear wheel is in toothed engagement with the toothed belt. This prevents the toothed belt slipping relative to the gear wheel, whereby errors during the determination of the steering rod position are avoided.

According to a further exemplary arrangement, the magnetic target object comprises a gear wheel and a permanent magnet fixed to the gear wheel, wherein the gear wheel is in toothed engagement with the spindle nut. This exemplary arrangement is advantageous since, in this case, belt slip does not falsify the measured result.

The expression “belt slip” means that the toothed belt slips relative to the spindle nut as the motor shaft rotates and does not drive the spindle nut, or not as desired. As a result, a discrepancy between the position of the motor shaft and the position of the spindle nut is produced.

As a result of the toothed engagement of the target object with the spindle nut, however, the absolute position of the spindle nut and thus the accurate steering angle can be detected even after belt slip has occurred.

The circuit can be accommodated in a housing, and the magnetic target object can be arranged outside the housing. As a result, the circuit is protected against damage and contamination, while the magnetic target object can be positioned flexibly. Accommodating the circuit in a separate housing also simplifies the sealing of the circuit.

According to a further exemplary arrangement, the circuit and the magnetic target object can be accommodated in a motor housing of the drive motor, and the magnetic target object can be co-rotationally coupled to a rotor of the drive motor. This achieves the advantage that no separate housing is required to accommodate the circuit, as a result of which the steering system is particularly compact. Here, the position of the spindle nut is derived from the position of the rotor.

The steering system may have a control unit, which is set up to determine a position of the steering rod by using the output signals supplied by the magnetic sensor and the revolution counter. For example, the control unit can determine the accurate position of the steering rod and consequently a steering angle by using the detected 360° position of the spindle nut and the number of revolutions.

The control unit may always processes the output values currently supplied by the sensors. A true power-on-function is implemented in this way.

The control unit may additionally set up to ascertain belt slip by using a discrepancy between a motor revolution and a revolution of the magnetic target object. Frequent occurrence of belt slip can point to wear of the toothed belt.

### BRIEF DESCRIPTION OF DRAWINGS

Further advantages and features of the disclosure can be gathered from the following description and from the appended drawings, to which reference is made. In the drawings:

FIG. 1 shows, schematically, a steering system,

FIG. 2 shows, schematically, a steering system according to the disclosure in a first exemplary arrangement,

FIG. 3 shows a detection device of the steering system from FIG. 2,

FIG. 4 shows a signal profile from sensors of the detection device during a steering operation,

FIG. 5 shows, schematically, a steering system according to the disclosure in a further exemplary arrangement,

FIG. 6 shows, schematically, a steering system according to the disclosure in a further exemplary arrangement,

FIG. 7 shows, schematically, a steering system according to the disclosure in a further exemplary arrangement, and

FIG. 8 shows, schematically, a cross section through a steering system according to the disclosure in a further exemplary arrangement.

### DETAILED DESCRIPTION

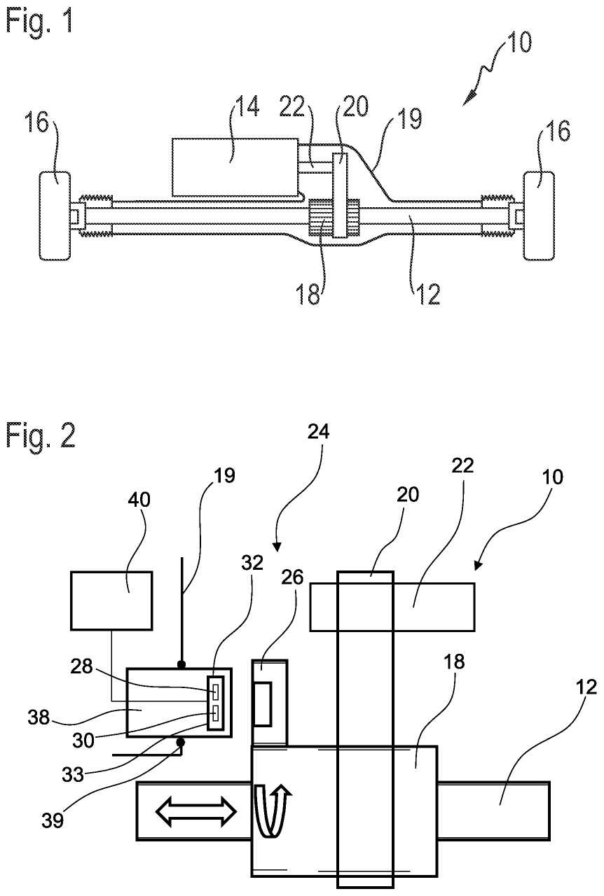

FIG. 1 shows, schematically, a steer-by-wire steering system 10 for a vehicle.

The steering system 10 comprises a linearly displaceable steering rod 12 and a drive motor 14, which is set up to displace the steering rod 12 to set a steering angle at wheels 16 of the vehicle.

For this purpose, the steering system 10 has a spindle nut 18 which is coupled to the steering rod 12 and can be rotated to displace the steering rod 12.

In practical terms, the spindle nut 18 can be rotated by the drive motor 14, wherein the drive motor 14 is connected to the spindle nut 18 via a toothed belt 20, which in turn is in engagement with a motor shaft 22 of the drive motor 14 and the spindle nut 18. The components of the steering system 10 are accommodated in a system housing 19.

In such steering systems 10, it is desired to be able to determine a current steering angle at any time. As a result, it is ensured that an electronically detected steering wheel position is always transformed correctly into a steering angle.

For this purpose, the steering system comprises a detection device 24 for detecting a rotational position of the spindle nut 18.

The detection device 24 is illustrated in FIG. 2, which shows, schematically, a steering system 10 according to the disclosure, which is likewise designed as a steer-by-wire steering system. For simplicity, only the motor shaft 22 of the drive motor 14 is illustrated in FIG. 2, and the steering rod 12 is truncated. In principle, the steering system 10 according to FIG. 2 is constructed correspondingly to the steering system 10 illustrated in FIG. 1.

By using the rotational position of the spindle nut 18, an absolute position of the steering rod 12 can be determined unambiguously. Thus, a steering angle can be determined indirectly by the detection device 24.

The detection device 24 comprises a magnetic target object 26, which is directly rotationally coupled to the spindle nut 18,

Furthermore, the detection device 24 comprises a magnetic sensor 28 for detecting the rotational position of the magnetic target object 26, and a revolution counter 30 for detecting a number of revolutions of the magnetic target object 26.

According to the disclosure, the magnetic sensor 28 and the revolution counter 30 are present in a common, integrated circuit 32.

In the figures, for simplicity, the magnetic sensor 28 and the revolution counter 30 are illustrated as separate regions on a printed circuit board 33.

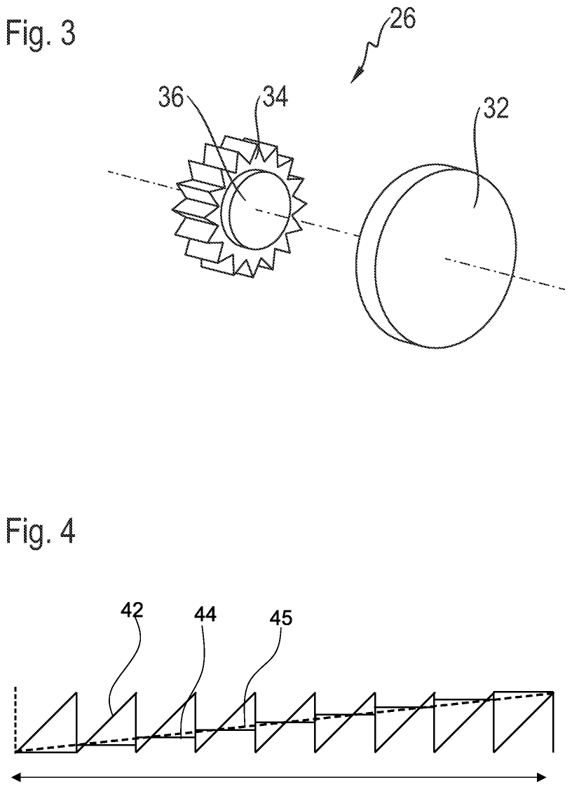

In the exemplary arrangement, the magnetic target object comprises a gear wheel 34 and a permanent magnet 36 fixed to the gear wheel 34, as illustrated in FIG. 3.

For the direct rotational coupling of the magnetic target object 26, the gear wheel 34 is in toothed engagement with the spindle nut 18.

The circuit 32 is accommodated in a housing 38, and the magnetic target object 26 is arranged outside the housing 38.

However, the target object 26 is arranged inside the system housing 19.

In the exemplary arrangement, the system housing 19 is sealed off relative to the housing 38 by a seal 39.

The housing 38 is arranged relative to the target object 26 in such a way that the sensors 28, 30 can reliably detect the magnetic field of the magnetic target object 26. A maximum possible spacing thus depends on the magnetic strength of the magnetic target object 26, that is to say on the size of the permanent magnet 36.

For example, the housing 38 is arranged in such a way that the circuit 32 or the printed circuit board overlaps the magnetic target object 26 in a view along the axis of rotation of the latter.

The steering system 10 further has a control unit 40, which is set up to determine a position of the steering rod 12 by using the output signals supplied by the magnetic sensor 28 and the revolution counter 30.

The output signals of the magnetic sensor 28 and the revolution counter 30 are illustrated in FIG. 4.

The output signal of the magnetic sensor 28 is illustrated by the graph 42, and the output signal of the revolution counter 30 is illustrated by the graph 44.

The output signal of the magnetic sensor 28 forms a sawtooth pattern, each tooth of the graph 42 corresponding to one revolution of the magnetic target object 26 through 360°.

This means that the profile of the graph 42 is repeated during each complete revolution of the magnetic target object 26.

The output signal of the revolution counter 30 is a signal rising stepwise.

The output signal of the revolution counter 30 is a resistance value.

By using the output signal of the revolution counter 30, it is possible to ascertain how many revolutions the magnetic target object 26 has made.

The revolutions are counted in relation to an initial position of the magnetic target object 26, the number of revolutions being counted up or counted down, depending on the direction of rotation.

By using the two signals, the control unit 40 can firstly determine the absolute position of the magnetic target object 26, that is to say the 360° position, and the number of revolutions.

In FIG. 4, a signal calculated by the control unit 40 from the signals of the magnetic sensor 28 and of the revolution counter 30 is illustrated by a dashed line 45. A specific value of the calculated signal is unambiguous for a position of the target object 26.

By taking account of the transmission ratio between the magnetic target object 26 and the spindle nut 18, the control unit can also determine the absolute position of the spindle nut, from which in turn an accurate position of the steering rod 12 and consequently a steering angle can be derived.

The maximum possible number of revolutions of the magnetic target object 26 can be restricted in both directions of rotation, for example to a maximum of 35 revolutions. The restriction results from the maximum travel of the steering rod 12.

If the maximum possible number of revolutions has been reached, a maximum steering angle has been set.

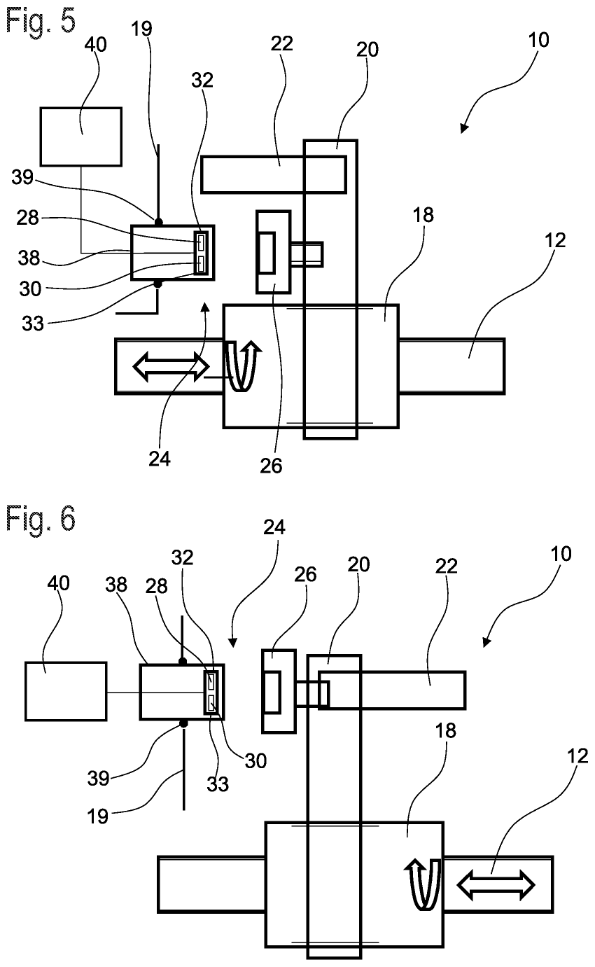

FIG. 5 illustrates, schematically, a further exemplary arrangement of a steering system 10.

The steering system 10 according to FIG. 5 differs from the steering system 10 according to FIG. 2 in the arrangement of the magnetic target object 26.

For example, the magnetic target object 26 is coupled mechanically to the toothed belt 20. In practical terms, the gear wheel 34 of the magnetic target object 26 is in toothed engagement with the toothed belt 20.

The determination of the steering angle is carried out in the same way as described in connection with FIG. 4, only the transmission ratio between the magnetic target object 26 and the spindle nut 18 being different.

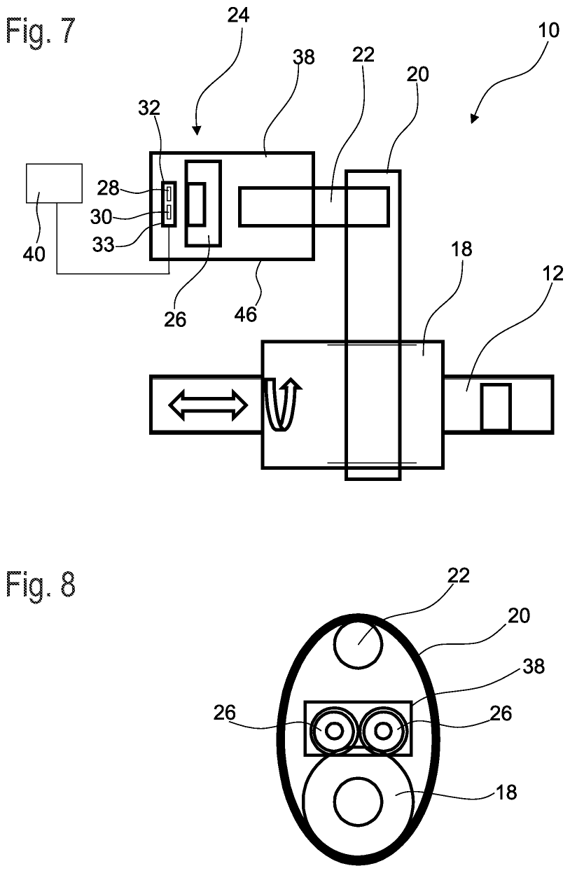

The same is true of FIGS. 6 and 7, which likewise each show, schematically, a further exemplary arrangement of a steering system 10, in which the magnetic target object 26 is accommodated at a different location in the steering system 10.

According to the exemplary arrangement illustrated in FIG. 6, the magnetic target object 26 is co-rotationally coupled to the motor shaft 22.

In the exemplary arrangement illustrated in FIG. 7, the circuit and the magnetic target object are accommodated in a motor housing 46 of the drive motor 14, and the magnetic target object 26 is co-rotationally coupled to a rotor of the drive motor 14, which is not illustrated for simplicity.

FIG. 8 illustrates a steering system 10 in which the detection device 24 is redundantly designed. For example, in the exemplary arrangement illustrated in FIG. 8, the detection device 24 illustrated in FIG. 2 is present twice.

Here, the circuits 32 of the two detection devices 24 can be accommodated in a common housing 38.

In order to produce redundancy, however, alternatively the detection devices 24 illustrated in FIGS. 2 and 5 to 7 can be combined with one another as desired.

The detection device 24 described above is not restricted to the use in a steer-by-wire steering system 10 but can equally well be used in an electric power steering system.

1. A steering system for a vehicle, comprising a linearly displaceable steering rod, a spindle nut which is coupled to the steering rod and which is rotatable to displace the steering rod, and a detection device for detecting a rotational position of the spindle nut, wherein the detection device comprises a magnetic target object, which is directly or indirectly rotationally coupled to the spindle nut, a magnetic sensor for detecting a rotational position of the magnetic target object, and a revolution counter for detecting a number of revolutions of the magnetic target object, wherein the magnetic sensor and the revolution counter are present in a common integrated circuit.

2. The steering system as claimed in claim 1, wherein the steering system comprises a drive motor for rotating the spindle nut, wherein the drive motor is connected to the spindle nut via a toothed belt, which is in engagement with a motor shaft of the drive motor and the spindle nut.

3. The steering system as claimed in claim 2, wherein the magnetic target object is co-rotationally coupled to the motor shaft.

4. The steering system as claimed in claim 2, wherein the magnetic target object is mechanically coupled to the toothed belt.

5. The steering system as claimed in claim 1, wherein the magnetic target object comprises a gear wheel and a permanent magnet fixed to the gear wheel.

6. The steering system as claimed in claim 4, wherein the gear wheel is in toothed engagement with the toothed belt.

7. The steering system as claimed in claim 1, wherein the magnetic target object comprises a gear wheel and a permanent magnet fixed to the gear wheel, wherein the gear wheel is in toothed engagement with the spindle nut.

8. The steering system as claimed in claim 1, wherein the circuit is accommodated in a housing, and the magnetic target object is arranged outside the housing.

9. The steering system as claimed in claim 2, wherein the circuit and the magnetic target object are accommodated in a motor housing of the drive motor, and the magnetic target object is co-rotationally coupled to a rotor of the drive motor.

10. The steering system as claimed in claim 1, wherein the steering system has a control unit, which is set up to determine a position of the steering rod by using output signals supplied by the magnetic sensor and the revolution counter.

11. The steering system as claimed in claim 2, wherein the magnetic target object comprises a gear wheel and a permanent magnet fixed to the gear wheel.

12. The steering system as claimed in claim 5, wherein the gear wheel is in toothed engagement with the toothed belt.

13. The steering system as claimed in claim 2, wherein the magnetic target object comprises a gear wheel and a permanent magnet fixed to the gear wheel, wherein the gear wheel is in toothed engagement with the spindle nut.

14. The steering system as claimed in claim 2, wherein the circuit is accommodated in a housing, and the magnetic target object is arranged outside the housing.

15. The steering system as claimed in claim 2, wherein the steering system has a control unit, which is set up to determine a position of the steering rod by using output signals supplied by the magnetic sensor and the revolution counter.
